(19) United States
(12) Patent Application Publication
(10) Pub. No.: US 2025/0123742 A1
(43) Pub. Date: Apr. 17, 2025

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: KOKI SHIRAISHI, Kanagawa (JP)

(21) Appl. No.: 18/915,116

(22) Filed: Oct. 14, 2024

(30) Foreign Application Priority Data
Oct. 16, 2023 (JP) 2023-178031

(51) Int. Cl. G06F 3/0486; G06F 3/0482; G06F 3/0487; H04N 1/00

(52) U.S. Cl. CPC G06F 3/0486; G06F 3/0487; G06F 3/0482; H04N 1/00411; H04N 1/00474; H04N 1/00506; H04N 1/00514; H04N 2201/0094

(57) ABSTRACT

In response to receipt of the user operation by the reception unit, the display control unit displays a confirmation screen indicating the screen in a state in which the predetermined area is set by the setting unit, and in a case where another user operation is performed to set the predetermined area on the confirmation screen, the display control unit displays the screen on which the predetermined area is set by the setting unit.

### BACKGROUND

### Field

The present disclosure relates to an information processing apparatus, a control method, and a storage medium.

### Description of the Related Art

Some display units of information processing apparatuses display content relating to a predetermined function. For example, there is a technique in which a display application button of an application program relating to a predetermined function is displayed, and in response to a selection of the application button, the application program relating to the predetermined function is activated. There is also another technique in which placement (layout) of each application button is changed. Japanese Patent Application Laid-Open No. 7205279 discusses an image forming apparatus which facilitates a setting change of display/undisplay of each application button to cause some specific application programs to be used by a user.

With the technique discussed in Japanese Patent Application Laid-Open No. 7205279 which is silent on processing relating to a predetermined area that displays no application button, user's convenience may be degraded in a content placement change.

### SUMMARY

The present disclosure is directed to improving user's convenience in a content placement change.

According to an aspect of the present disclosure, an information processing apparatus having a plurality of functions, the information processing apparatus includes a display control unit configured to display a screen on which a soft key indicating any one of the plurality of functions is placed, the screen including a background image, a reception unit configured to receive a user operation performed to select a predetermined area where the soft key is not to be placed, in an area on the screen where the soft key is able to be placed, and a setting unit configured to set the predetermined area, wherein, in response to receipt of the user operation by the reception unit, the display control unit displays a confirmation screen indicating the screen in a state in which the predetermined area is set by the setting unit, and in a case where another user operation is performed to set the predetermined area on the confirmation screen, the display control unit displays the screen on which the predetermined area is set by the setting unit.

Further features of the present disclosure will become apparent from the following description of exemplary embodiments with reference to the attached drawings.

### BRIEF DESCRIPTION OF THE DRAWINGS

FIG. 1 is a diagram illustrating a hardware configuration of an image processing apparatus.

FIG. 2 is a diagram illustrating an example of an external view of an operation unit of the image processing apparatus.

FIG. 3 is a diagram illustrating a software configuration of the image processing apparatus.

FIGS. 4A to 4F are diagrams each illustrating an operation screen which receives a placement disabled area setting and a content placement change.

FIG. 5 is a flowchart illustrating processing for a placement disabled area setting and content placement.

FIG. 6 is a diagram illustrating a management table of setting information set as a placement disabled area.

FIGS. 7A to 7K are diagrams each illustrating an operation screen that receives a placement disabled area setting and a content placement change.

FIGS. 8A to 8F are diagrams each illustrating an operation screen which receives a placement disabled area setting and a content placement change.

FIGS. 9A to 9F are diagrams each illustrating an operation screen which receives a placement disabled area setting and a content placement change.

FIG. 10 is a flowchart illustrating processing for automatically setting a placement disabled area.

### DESCRIPTION OF THE EMBODIMENTS

Hereinafter, exemplary embodiments of the present disclosure will be described with reference to the accompanying drawings. The following exemplary embodiments are not intended to limit the present disclosure according to the scope of the claims, and not all combinations of features described in the exemplary embodiments are necessarily essential to the solving means of the present disclosure. In the accompanying drawings, the same or similar components are denoted by the same reference numerals, and the redundant descriptions will be omitted.

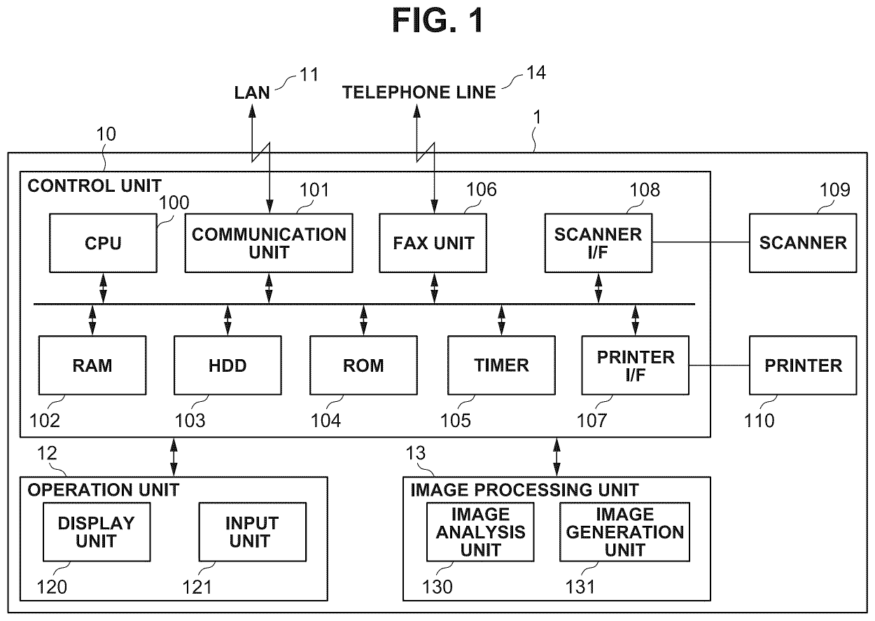

A first exemplary embodiment will be described below. FIG. 1 is a block diagram illustrating a configuration of an image processing apparatus (information processing apparatus) 1. The image processing apparatus 1 is a multifunction peripheral (MFP) printer having the following functions, for example. Instead of an MFP, the image processing apparatus 1 may be a single-function peripheral. A printing method applicable to the image processing apparatus 1 may be any method including the electrophotographic method and the inkjet method. The image processing apparatus 1 is such an apparatus that has a home screen in which placement (positions) of application buttons is changeable. For example, the image processing apparatus 1 may be a personal computer (PC), a tablet terminal, or a smartphone.

The image processing apparatus 1 includes a control unit 10, an operation unit 12, an image processing unit 13, a scanner 109, and a printer 110. The control unit 10 controls operation of units of the image processing apparatus 1. The control unit 10 includes a CPU 100, a communication unit 101, a random access memory (RAM) 102, a hard disk drive (HDD) 103, a read only memory (ROM) 104, a timer 105, a FAX unit 106, a scanner interface (I/F) 108, and a printer I/F 107.

The CPU 100 controls entire operation of control unit 10. The RAM 102 functions as a work memory of the CPU 100. The HDD 103 stores application programs and image data. The HDD 103 may be a storage medium, such as an optical medium and a flash memory. The ROM 104 stores programs to be read by the CPU 100. The HDD 103 may be configured to be attachable to and detachable from the image processing apparatus 1 as an external storage device. The timer 105 manages time, and the CPU 100 references the timer 105 to acquire time information.

The communication unit 101 connected to a local area network (LAN) 11 controls data communication via the LAN 11. The FAX unit 106 connected to a telephone line 14 controls data communication via the telephone line 14.

The operation unit 12 includes a display unit 120 on which a touch panel sheet is attached, and an input unit 121, such as hardware keys. The operation unit 12 displays screens on the display unit 120 and receives user operations via the display unit 120 or the input unit 121. While, in the present exemplary embodiment described below, a liquid crystal display is used as the display unit 120, other types of display are also applicable. While, in the present exemplary embodiment, a touch panel is used as the input unit 121, different interfaces, such as a mouse, are also usable.

The image processing unit 13 that is controlled by the control unit 10 includes an image analysis unit 130 and an image generation unit 131. The image analysis unit 130 analyzes a document image structure and extracts information to be used from a result of the analysis. The image generation unit 131 reads a document via the scanner 109 and digitizes the image of the document to generate image data. The generated image data is stored in the HDD 103. The image generation unit 131 can also generate document image data in a different format by using the information extracted in the analysis performed by the image analysis unit 130.

The image processing apparatus 1 has a copy function, a scan function, a print function, and other predetermined functions. The copy function executes a copy job in which document is read by the scanner 109 and an image is printed on the printer 110 based on image data of the read document. The scan function executes a transmission job in which a document is read via the scanner 109 and generated image data is transmitted by the communication unit 101. The print function executes a print job in which an image is printed on a sheet based on print data received from an image processing apparatus, such as an external PC, via the communication unit 101.

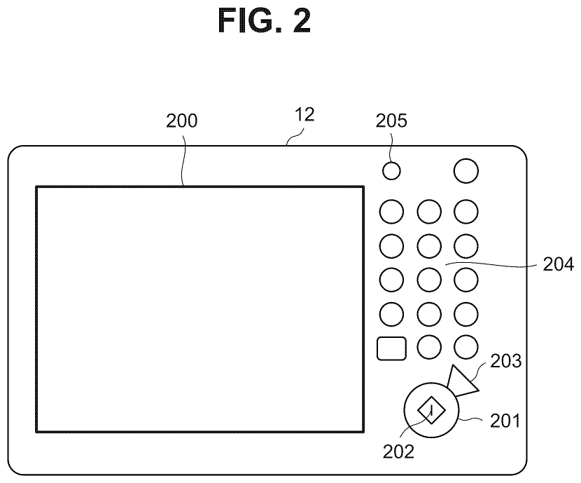

FIG. 2 is a diagram illustrating an example of an external view of the operation unit 12 in FIG. 1.

A touch panel 200 is a liquid crystal display with a touch panel sheet attached thereon. The touch panel 200 displays operation screens and soft keys and informs, in response to a selection of a displayed key, the CPU 100 of positional information of the displayed key. The CPU 100 performs predetermined processing based on the acquired positional information. In this case, the touch panel 200 functions as the display unit 120 in FIG. 1 and also functions as the input unit 121 in FIG. 1.

Various keys and buttons that are operated by the user will be described below. A start key 201 is used to issue an instruction to cause the scanner 109 to start an operation for document reading. The central part of the start key 201 has a two-color (green and red) light emitting diode (LED) 202 that indicates whether the start key 201 is enabled. A stop key 203 is used to stop the current operation. A numeric keypad 204 including numeric and symbol keys is used to set the number of copies and issue an instruction to cause a screen transition of the touch panel 200. A user mode key 205 is used to call a user mode. The user mode is used in a setting for the image processing apparatus 1.

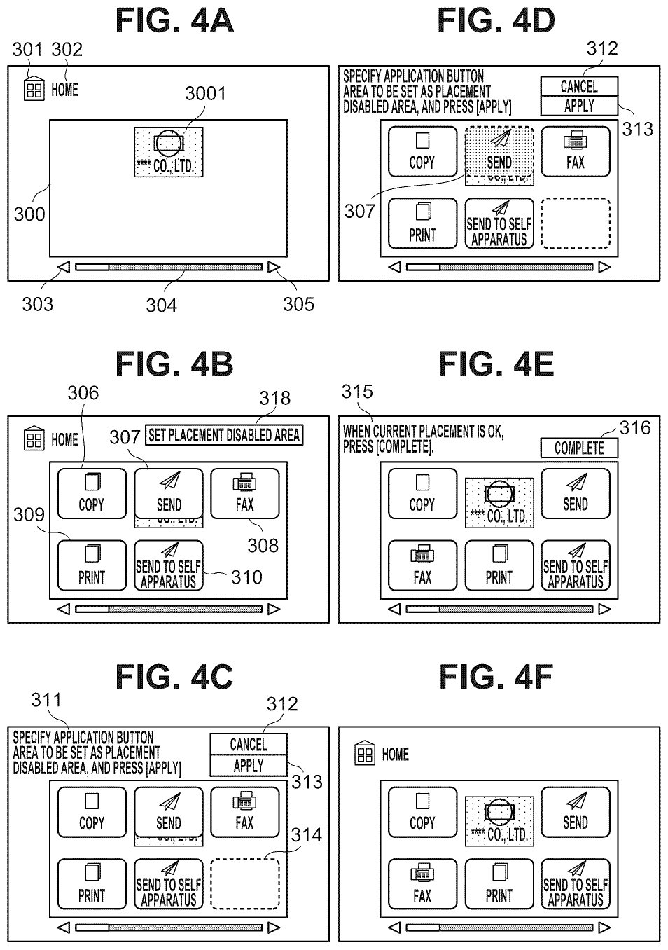

The operation unit 12 of the image processing apparatus 1 can display content relating to a predetermined function. The content refers to an application button relating to a predetermined function, for example. In response to a selection of a displayed application button, an application program corresponding to the predetermined function is activated. More specifically, each of application buttons 306 to 310 in FIGS. 4A to 4F (described below) are the content in the present exemplary embodiment. The operation unit 12 allows the user to set the background image (an image displayed as the background of the placed content) and displays the background image and one or a plurality of pieces of the content. Examples of a screen that can display the background image and the content include a home screen including one or a plurality of pages. The home screen is a screen on which the user selects one of pieces of the content relating to predetermined functions. For example, the home screen is displayed after the image processing apparatus 1 is supplied with power and then activated. In a case where the image processing apparatus 1 has a user authentication function, the home screen is displayed in response to completion of the user authentication processing.

When the content is placed on the background image that is displayed on the operation unit 12, a predetermined area (object) included in the background image may overlap with the content. For example, in a case where a predetermined logo is included in the background image, the predetermined logo included in the background image may overlap with the content. However, there can be a case where a predetermined logo is desired to be displayed without being overlapped with the content. In such a case, the overlapping of the content over the predetermined logo may degrade user's convenience.

In the present exemplary embodiment, a method for setting a predetermined area (placement disabled area) where displaying of the content is disabled, on a home menu 300 of the operation unit 12.

The placement disabled area refers to an area where placement and displaying of the content are disabled. Since no content is displayed in the placement disabled area on the operation unit 12, a predetermined logo on the background image is displayed in the placement disabled area. On the operation unit 12, the area not set as the placement disabled area is an area where the content is able to be displayed. Therefore, the content can be placed and displayed in an area where displaying of the content is enabled. With this configuration, both a predetermined logo of the background image and the content are displayed on the operation unit 12.

Thus, for a case where a predetermined logo is displayed without being overlapped with the content, displaying of the predetermined logo and displaying of the content are performed without overlapping each other, which improves user's convenience.

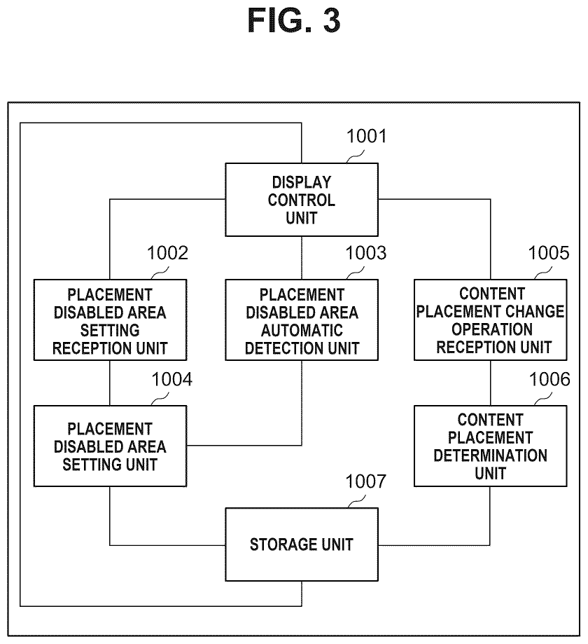

FIG. 3 is a diagram illustrating a software configuration of the image processing apparatus 1.

A display control unit 1001 displays the home screen on which the background image and the content are displayed, and performs display control in accordance with information stored in a storage unit based on a predetermined operation performed on the home screen.

A placement disabled area setting reception unit 1002 receives a placement disabled area setting.

A placement disabled area automatic detection unit 1003 automatically detects a placement disabled area.

A placement disabled area setting unit 1004 sets the placement disabled area.

A content placement change operation reception unit 1005 receives an operation for a content placement change.

A content placement determination unit 1006 determines content placement.

A storage unit 1007 stores the set placement disabled area and stores the determined content placement area.

The image processing apparatus 1 further includes a display control unit for displaying the background image and application buttons on the operation unit 12, based on the application button placement set by the placement disabled area setting unit 1004 and an application button placement control unit.

FIGS. 4A to 4F are diagrams each illustrating an operation screen which receives a placement disabled area setting and a content placement change. Processing for receiving a user operation for a placement disabled area setting and a content placement change in the home screen displayed on the operation unit 12 will be described below with reference to FIGS. 4A to 4F.

FIG. 4A illustrates that an image including a predetermined logo is set as the background image set in the home menu 300 on the home screen. The screen including no content in FIG. 4A is shown to describe the background image. The home screen actually displayed on the operation unit 12 is illustrated from FIGS. 4B to 4F.

An icon 301 represents the home screen. A menu name 302 indicates the home screen. The home menu 300 displays the current page. In response to the user sliding a slide bar 304 in a predetermined direction or presses an arrow 303 to move to the preceding page, the current page changes. The current page also changes in response to the user pressing an arrow 305 to move to the following page or flicking a position in the area of the home menu 300.

FIG. 4B illustrates the home screen in which application buttons 306 to 310 are placed and displayed in the home menu 300 to which the background image in FIG. 4A is set. In response to the user pressing (selecting) a button 318, the placement disabled area setting in the home screen is started. While the button 318 is displayed at the top of the home screen, the present disclosure is not limited thereto. For example, a predetermined setting area (setting menu) for various function settings of the image processing apparatus 1 may be selected, and the button 318 may be displayed in a setting screen on which the placement disabled area included in the predetermined setting area is to be set.

FIG. 4C illustrates a state where a blank area 314 is visualized after the user has pressed the button 318 for the placement disabled area setting in the home screen in FIG. 4B, and the placement disabled area setting is started. A blank area refers to an area where no application button is placed in the application button placement area set for each home screen. A guidance 311 displays a message to prompt a user to perform an operation. In response to a button 312 being pressed, the CPU 100 performs processing to cancel the current placement disabled area setting. In response to a button 313 being pressed, the CPU 100 performs processing to reflect the current placement disabled area setting. The blank area 314 is displayed in a case where the page on which the placement disabled area setting is performed includes a blank area where no application button is placed. The blank area 314 is surrounded by a dashed line to cause the user to recognize that the area is an application button placement area.

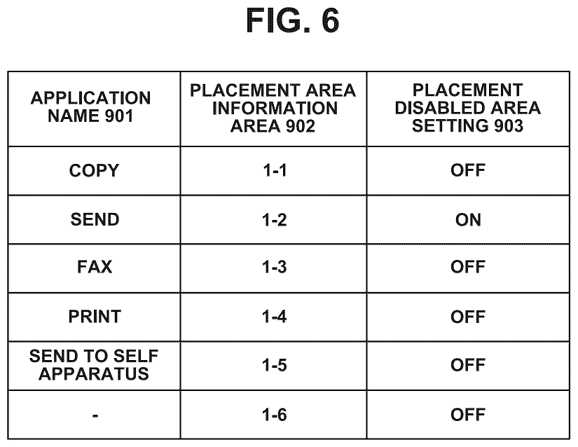

FIG. 4D illustrates the home screen that is displayed after the user has selected, as the placement disabled area, an application button placement area where the application button 307 has been placed. The user operation performed in this processing is pressing the application button 307. As a result of this operation, the placement area selected as the placement disabled area is displayed in a display format different from unselected placement areas. For example, the selected placement area is surrounded by a dashed line, and the application button is displayed in a gray-out state. This helps the user to visually distinguish the selected application button from unselected buttons. In response to the user pressing the button 313 (application button) in this state, the apparatus enters the state in FIG. 4E. The CPU 100 stores setting information relating to the applied application button placement areas each in association with a different placement areas, as described by an information table illustrated in FIG. 6.

FIG. 4E illustrates a state where the placement disabled area setting is reflected, and the application button 307 having been placed in the placement disabled area is moved and automatically placed. A guidance 315 displays a message that prompts the user to complete the placement disabled area setting. In response to the user pressing a button 316, the application button placement in the current home screen is applied. The application button 307 having been placed in the placement disabled area moves in a Z-direction (described below) by one area. In this case, the application button 307 is moved to the right by one area and placed in the upper row. An application button 308 is moved to the leftmost area in the lower row, and the application buttons 309 and 310 are moved to the right by one area and placed.

FIG. 4F illustrates the home screen displayed after the button 316 (complete button) in FIG. 4E has been pressed, the placement disabled area setting has been performed, and the placement areas of the application buttons 306 to 310 have been determined.

Each of the application button placement areas where application buttons are placed in the home screen is assigned a placement priority as predetermined information indicating the order of application button placement. In a case where an application button is placed in the placement disabled area at the time of the placement disabled area setting, the CPU 100 determines a placement area for the target application button based on the placement priority and then places the target application button and displays the application button in the placement area. In an example case where the home screen includes six application placement areas like the present exemplary embodiment, the areas at the upper left, upper center, upper right, lower left, lower center, and lower right have higher priorities in this order in terms of application button placement. More specifically, the priority of application button placement increases along the Z-direction of the home screen. For example, application buttons are placed in order of the areas where the application buttons 306, 307, 308, 309, 310 (FIG. 4B) are placed, respectively, and the area 314 (FIG. 4C). The number of application buttons capable of being placed is not limited to six but may be other numbers. The priority of application placement areas increases along the Z-direction regardless of the number of application buttons capable of being placed.

The movement in the Z-direction will be described below. The movement in the Z-direction will be described below centering on an example case of moving an application button. In a case where the top row is the first row and the bottom row is the second row in the home menu 300, the application button placed at the leftmost position in the top row on the first page moves to the rightmost position in the first row. The application button placed at the leftmost position in the second row moves in the direction toward the rightmost position in the second row. More specifically, an application button placed in a predetermined row moves to the right in the predetermined row. The application button placed at the rightmost position in the first row moves to the leftmost position in the second row. More specifically, the application button placed at the rightmost position in a predetermined row moves to the leftmost position (in the lower left direction) in the row following (below) the predetermined row. The application button placed at the rightmost position in the second row moves to the leftmost position in the first row on the next page. More specifically, the application button placed at the rightmost position in the last row of the predetermined page moves to the leftmost position in the first row of the page following the predetermined page. In the subsequent pages, each application button moves to the corresponding direction based on the coordinates where each application button is positioned. The home menu 300 in the home screen includes the first and the second rows in one page, each row includes three application button placement areas, and up to six application buttons can be placed in a predetermined page. The home menu 300 may include at least two rows in a predetermined page, and at least three application buttons may be placed in a predetermined row, and at least six application buttons may be placed in the predetermined page.

Even with such a configuration, the movement of application buttons in the Z-direction is similar to the above.

The movement in the direction opposite to the Z-direction will be described below. An application button placed in a predetermined row moves to the left in the predetermined row. The application button placed at the leftmost position in the predetermined row moves to the rightmost position in the row preceding the predetermined row. The application button placed at the leftmost position in the top row on a predetermined page moves to the rightmost position in the last row on the page preceding the predetermined page.

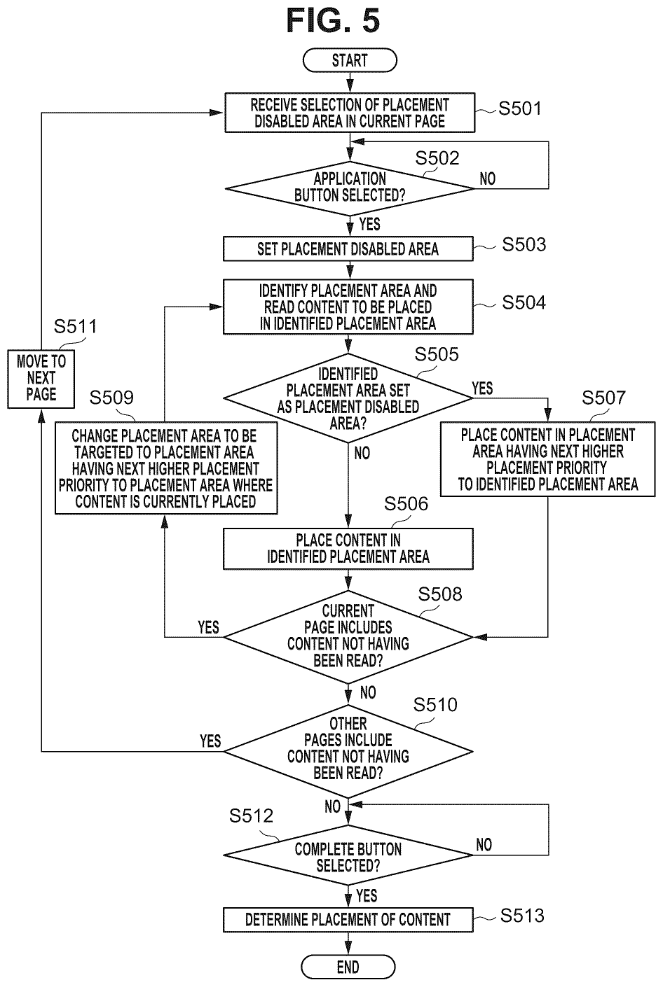

FIG. 5 is a flowchart illustrating processing that is performed in the placement disabled area setting and content placement.

The program according to the present exemplary embodiment is stored in the HDD 103 of the image processing apparatus 1 and is loaded into the RAM 102 and executed by the CPU 100.

The processing of this flowchart is started in response to the user selecting (pressing) the button 318 and the operation unit 12 entering a state (mode) in which the placement disabled area setting is started. The processing of this flowchart may be started in response to not only the button 318 being selected but also a predetermined instruction for starting the placement disabled area setting being issued and the operation unit 12 enters a mode in which the placement disabled area setting is performed. The predetermined instruction to start the placement disabled area setting may be issued in a setting screen (not illustrated).

In step S501, the CPU 100 receives a selection of the placement disabled area on the current page in the home screen. More specifically, as described above with reference to FIG. 4D, the CPU 100 receives an application button selection operation.

In step S502, the CPU 100 determines whether the button 318 has been selected. In a case where the CPU 100 determines that the button 318 has been selected (YES in step S502), the processing proceeds to step S503. In a case where the CPU 100 determines that the button 318 has not been selected (NO in step S502), the CPU 100 repeats the processing in step S502.

In step S503, the CPU 100 sets, as the placement disabled area, the placement area where the selected application button is placed.

In step S504, based on the placement priority, the CPU 100 identifies the placement area. More specifically, in a case where the CPU 100 performs the processing in step S502 for the first time after entering the processing of this flowchart, the CPU 100 identifies the placement area having the highest placement priority. Then, the CPU 100 reads the content to be placed in the identified placement area.

In step S505, the CPU 100 determines whether the identified placement area is set as the placement disabled area. More specifically, the CPU 100 references information about whether the identified placement area is set as the placement disabled area, based on the information table in FIG. 6 stored in the RAM 102. Then, the CPU 100 determines whether the certain placement area is set as the placement disabled area. The information table will be specifically described below with reference to FIG. 6.

FIG. 6 illustrates the information table in which whether each placement area is set as the placement disabled area is managed. In a case where the placement disabled area is set in step S503 in the flowchart in FIG. 5, the information is stored in this table.

This table includes an application name 901, placement area information 902, and placement disabled area setting information (placement disabled setting) 903. The application name 901 indicates the application button placed in the placement area when the flowchart in FIG. 5 is started. The placement area information 902 indicates the position of the placement area. Values “1-1” to “1-6” indicate higher priorities in this order based on the above-described placement priority. The placement disabled area setting information 903 indicates whether the placement area corresponding to the placement area information 902 is set as the placement disabled area. “ON” indicates that the corresponding placement area is set as the placement disabled area, and “OFF” indicates that the corresponding placement area is not set as the placement disabled area.

The symbol “-” in the application name 901 indicates that no application button is placed in the area corresponding to the placement area information 902, i.e., a blank area. In a case where the CPU 100 determines that the identified placement area is set as the placement disabled area (YES in step 505), the processing proceeds to step S507. In a case where the CPU 100 determines that the identified placement area is not set as the placement disabled area (NO in step 505), the processing proceeds to step S506.

In step S506, the CPU 100 places the read application button in the currently identified placement area.

In step S507, the CPU 100 places the read application button in the placement area having the next higher priority to the currently identified placement area.

In step S508, the CPU 100 determines whether the page currently displayed in the home screen includes a placement area where no application button is read, i.e., the determination in step S505 has not been performed. In a case where the CPU 100 determines that the page currently displayed in the home screen includes a placement area where no application button is read (YES in step S508), the processing proceeds to step S509. In a case where the CPU 100 determines that the page currently displayed in the home screen does not include a placement area where no application button is read (NO in step S508), the processing proceeds to step S510.

In step S509, the CPU 100 changes the placement area to be targeted to a placement area having the next higher placement priority to the placement area where an application button is currently placed.

In step S510, the CPU 100 determines whether a page other than the page currently displayed in the home screen includes a placement area where no application button is read, i.e., the determination in step S505 has not been performed. In a case where the CPU 100 determines that a page other than the page currently displayed in the home screen includes a placement area where no application button is read (YES in step S510), the processing proceeds to step S511. In a case where the CPU 100 determines that a page other than the page currently displayed in the home screen does not include a placement area where no application button is read (NO in step S510), the processing proceeds to step S512.

In step S511, the CPU 100 sets the page including a placement area where no application button is read, as the next page, and subjects the next page to the processing in step S501 and subsequent steps.

In step S512, the CPU 100 determines whether the button 316 has been selected.

In a case where the CPU 100 determines that the button 316 has been selected (YES in step S512), the processing proceeds to step S513. In a case where the CPU 100 determines that the button 316 has not been selected (NO in step S512), the CPU 100 repeats the processing in step S512.

In step S513, the CPU 100 determines (applies) the application button placement. Then, the CPU 100 exits the processing in this flowchart.

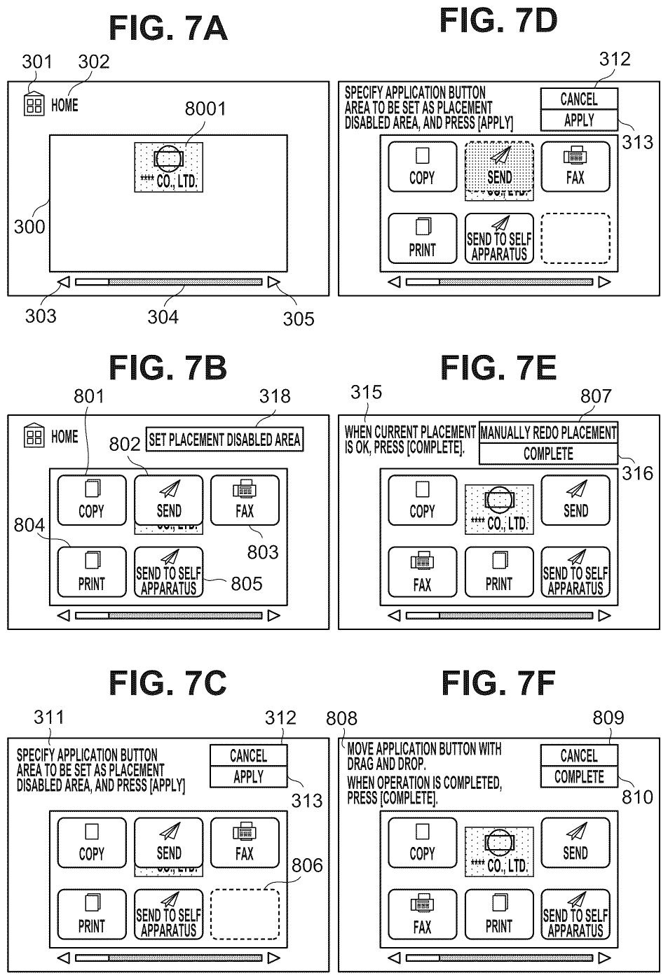

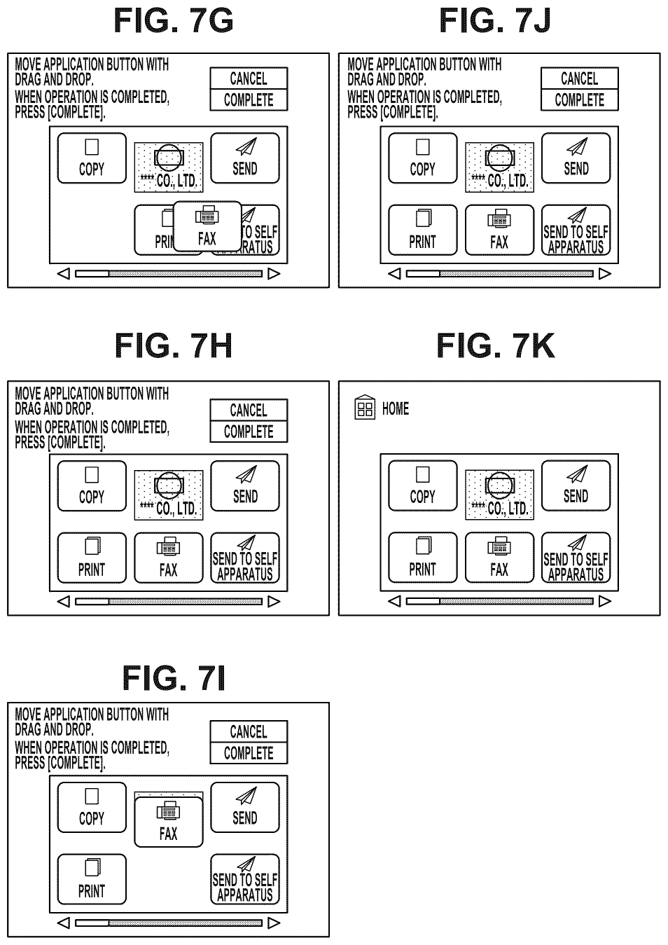

Processing that is performed in receiving an operation to change the content placement displayed on the operation unit 12 after the placement disabled area setting will be described below with reference to FIGS. 7A to 7I.

Processing in FIGS. 7A to 7D is similar to the processing in FIGS. 4A to 4D, respectively, and the redundant descriptions will be omitted.

FIG. 7E illustrates a state where the placement disabled area setting is reflected in response to the button 313 being pressed in a state in FIG. 7D, and an application button 802 having been placed in the placement disabled area are moved and automatically placed again. The guidance 315 displays a message that prompts the user to perform an operation to complete the placement disabled area setting. In response to the user pressing the button 316, the application button placement in the current home screen is applied. The application button 802 having been placed in the placement disabled area is moved in the Z-direction (described below) by one area. The application button 802 is moved to the right by one area in the upper row. An application button 803 is moved to the leftmost area in the lower row, and application buttons 804 and 805 are moved to the right by one area. FIG. 7E illustrates a (manual placement redo) button 807.

FIG. 7F illustrates a state the CPU 100 is ready to receive a user's manual application button operation after the button 807 has been pressed in FIG. 7E. A guidance 808 describes an operation to move an application button and an operation to complete an application button placement redo operation after the placement disabled area setting. Pressing a button 809 cancels the current application button placement setting and causes processing for returning to the state before the placement disabled area setting. Pressing a button 810 applies the application button placement at the timing of a pressing operation performed on the button 810.

FIG. 7G illustrates a state where the application button 803 is being moved by a user's drag operation.

FIG. 7H illustrates a state where the positions of the application buttons 803 and 804 are exchanged.

FIG. 7I illustrates a state where the user drags the application button 803 and overlaps the application button 803 with the area set as the placement disabled area.

FIG. 7J illustrates a state where the user has performed a drop operation (i.e., the user releases an indicator such as the finger from the home screen on the operation unit 12) in the state in FIG. 7I, and the application button 803 is placed in a placement area where the application button 803 has been placed before the drag operation. This means that, even in a case where the user performs an operation to place the application button 803 in the placement disabled area, the application button 803 is not placed in the placement disabled area.

FIG. 7K illustrates the home screen displayed when the button 810 in FIG. 7J has been pressed, the placement disabled area setting has been performed, and the placement areas of application buttons 801 to 805 have been determined.

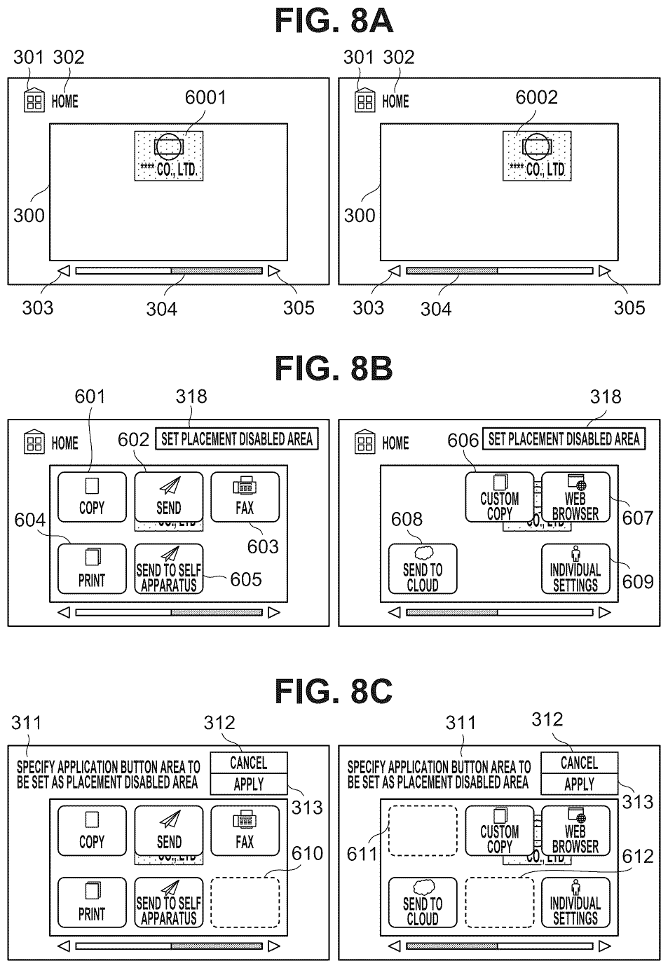

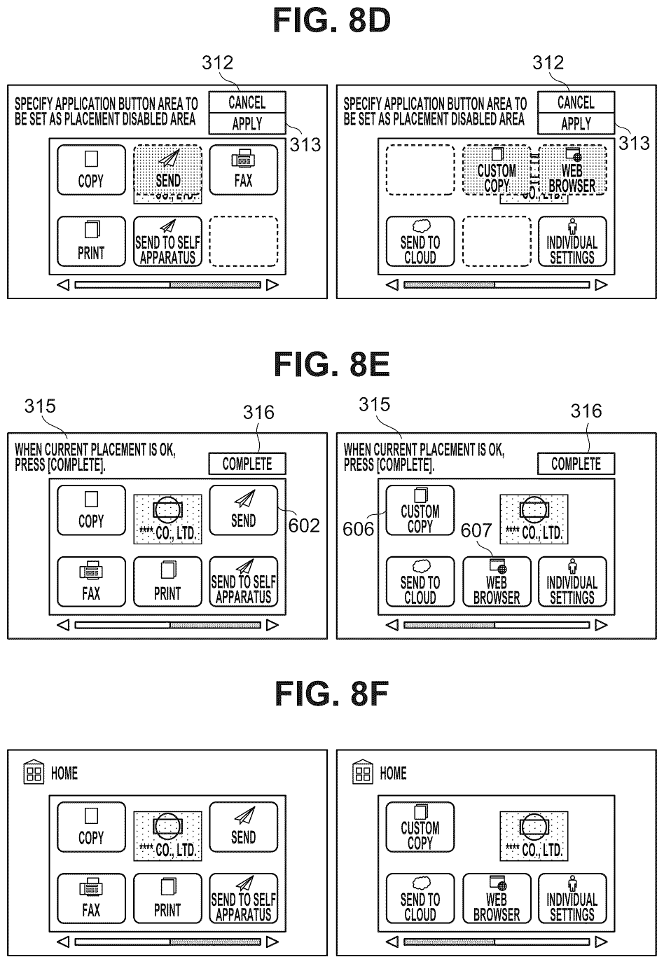

Processing for the placement disabled area setting in a case where the background image and the content are displayed on a plurality of pages will be described below with reference to FIGS. 8A to 8F. More specifically, a case where a different background image is set for each page will be described below. By performing a horizontal drag-and-drop operation on the slide bar 304, the user can move to a desired page.

FIG. 8A illustrates the home screen set for each page, in which a background image including a logo 6001 or 6002 is placed. The page on the left-hand side is the first page, and the page on the right-hand side is the second page (this page relation also applies to FIGS. 8B to 8F). Other elements are similar to those in FIG. 4A, and the redundant descriptions will be omitted.

FIG. 8B illustrates the home screen in which application buttons 601 to 609 are placed in the home menu 300 for each page having the background setting in FIG. 8A.

FIG. 8C illustrates a state where the placement disabled area setting for the home screen in FIG. 8B is started. Other elements are similar to those in FIG. 4C, and redundant descriptions will be omitted. Areas 610, 611, and 612 are blank areas.

FIG. 8D illustrates the home screen displayed after the user has selected, as placement disabled areas, placement areas where the application buttons 602, 606, and 607 are allocated.

FIG. 8E illustrates a state where the button 313 in the left-hand or right-hand side screen has been pressed in the state in FIG. 8D, the placement disabled area setting has been reflected, and the application buttons 602, 606, and 607 placed in the placement disabled areas has been moved and automatically placed again. Other elements are similar to those in FIG. 4E, and the redundant descriptions will be omitted. In response to the user pressing the button 316 to apply the application button placement in the left-hand or right-hand side screen in FIG. 8E, the home screen enters the state in FIG. 8F.

FIG. 8F illustrates the home screen displayed after the placement disabled area setting has been performed and the placement areas of the application buttons 601 to 609 has been determined.

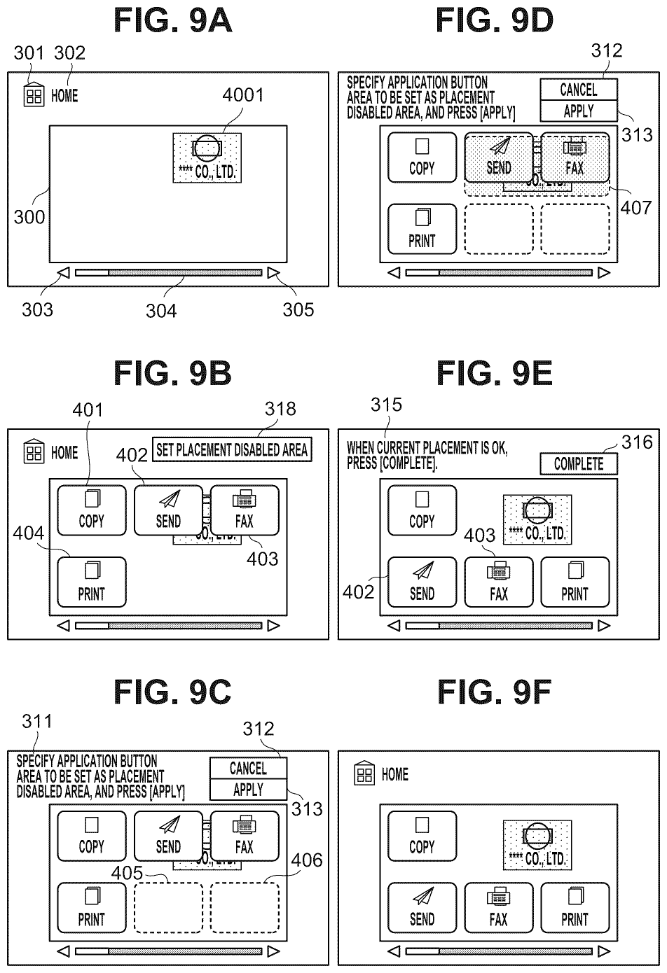

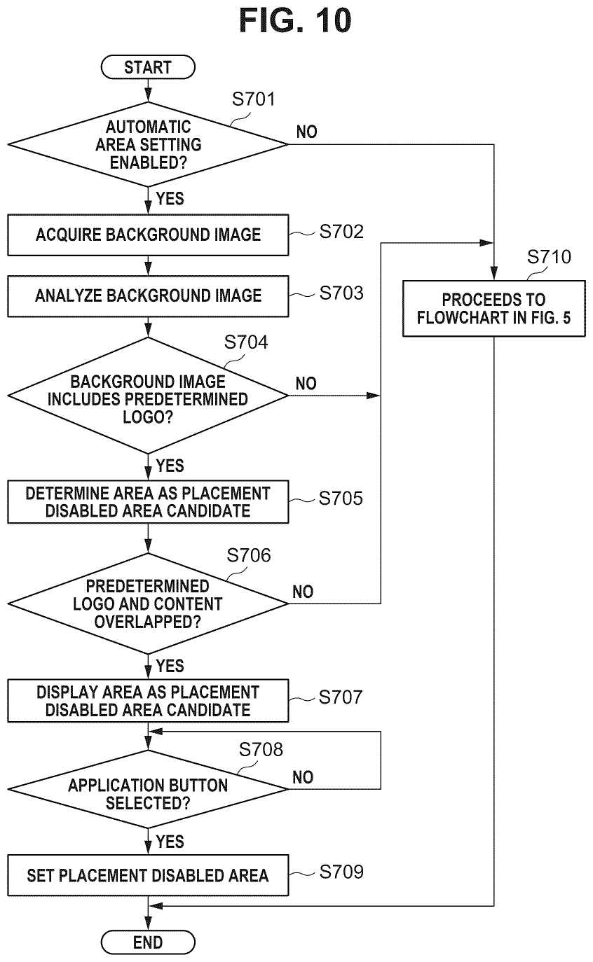

Processing for setting, as the placement disabled areas, an area specified based on a predetermined user operation on the operation unit 12 will be described below with reference to FIGS. 9A to 9F. In FIG. 4, processing for setting, as the placement disabled areas, the placement area selected on the operation unit 12 has been described. In FIGS. 9A to 9F, processing for setting, as the placement disabled areas, areas based on a predetermined user operation on the operation unit 12 will be described.

Examples of predetermined user operations include a drag-and-drop operation on the operation unit 12.

FIG. 9A illustrates the home screen displaying the background image including a logo 4001. Other elements are similar to those in FIG. 4A, and the redundant descriptions will be omitted.

FIG. 9B illustrates the home screen in which application buttons 401 to 404 are placed in the home menu 300 having the background setting in FIG. 9A. Other elements are similar to those in FIG. 4A, and the redundant descriptions will be omitted.

FIG. 9C illustrates a state where the placement disabled area setting for the home screen in FIG. 9B. Other elements are similar to those in FIG. 4C, and the redundant descriptions will be omitted. Areas 405 and 406 are blank areas.

FIG. 9D illustrates the home screen displaying an area 407 specified to be set as the placement disabled area by a predetermined operation using an input indicator such as the user's finger. Examples of the predetermined operation include a drag-and-drop operation. In a case where the user points the upper left corner of the area 407, performs a drag operation toward the lower right corner of the area 407, and then performs a drop operation on the lower right corner of the area 407, the area 407 is set as the placement disabled area.

FIG. 9E illustrates the home screen in a state where the button 313 has been pressed in the state in FIG. 9D, the placement disabled area setting has been reflected, and the application buttons 402 and 403 placed in the placement disabled area have been placed in placement enabled area. The guidance 315 displays a message that prompts the user to complete the placement disabled area setting. In response to the user pressing the button 316, the application button placement in the current home screen is applied, and the home screen enters the state in FIG. 9F.

FIG. 9F illustrates the home screen displayed after the placement disabled area setting has been performed, and the placement areas of the application buttons 401 to 404 have been determined.

The present exemplary embodiment has been described above centering on a form in which a setting unit is disposed for a setting of a predetermined area (placement disabled area) where no content can be displayed on the home menu 300 on the operation unit 12. Since no content is displayed in the placement disabled area on the operation unit 12, a predetermined logo of the background image can be displayed in the certain area. On the operation unit 12, areas not set as the placement disabled area is an area where the content can be displayed. Thus, the content can be placed and displayed in an area where displaying of the content is enabled. Consequently, the predetermined logo of the background image and the content can be displayed on the operation unit 12.

With the above-described configuration, in a case where a predetermined logo is desired to be displayed without being overlapped with the content, the predetermined logo and the content are not overlapped each other, which improves user's convenience.

The first exemplary embodiment has been described above centering on the form in which the content or an area selected by the user is set as the placement disabled area.

A second exemplary embodiment will be described below centering on a form in which detection of whether a background image displayed in a content placement area includes a predetermined logo is automatically performed, and an area including the predetermined logo is automatically set as the placement disabled area.

According to the present exemplary embodiment, the image processing apparatus 1 is provided with an automatic area setting (not illustrated) for enabling a function of automatically setting the area including a predetermined logo, as the placement disabled area. For example, the image processing apparatus 1 is provided with a function of automatically setting the area including a predetermined logo in the predetermined setting area, as the placement disabled area, and allows the user to enable or disable the setting of the function. The image processing apparatus 1 enables the function of automatically setting the area including a predetermined logo as the placement disabled area, based on an instruction to enable the function of automatically setting the area including a predetermined logo as the placement disabled area. Alternatively, the image processing apparatus 1 disables the function of automatically setting the area including a predetermined logo as the placement disabled area, based on an instruction to disable the function of automatically setting the area including a predetermined logo as the placement disabled area.

FIG. 10 is a flowchart illustrating processing for automatically performing the placement disabled area setting via an automatic detection method. The automatic detection method refers to a series of execution methods including processing performed by the CPU 100 to automatically detect a logo and text from the background image. The program according to the present exemplary embodiment is stored in the HDD 103 of the image processing apparatus 1, loaded into the RAM 102, and executed by the CPU 100.

The processing of this flowchart is started in response to the user selecting (pressing) the button 318 and the operation unit 12 entering a state for starting the placement disabled area setting. The processing of this flowchart may be started in response to not only the button 318 being selected but also when a predetermined instruction to start the placement disabled area setting being issued and the operation unit 12 entering a placement disabled area setting mode. The predetermined instruction to start the placement disabled area setting may be issued in a setting screen (not illustrated).

In step S701, the CPU 100 determines whether the automatic area setting is enabled.

In a case where the CPU 100 determines that the automatic area setting is enabled (YES in step S701), the processing proceeds to step S702. In a case where the CPU 100 determines that the automatic area setting is not enabled (NO in step S701), the processing proceeds to step S710.

In step S710, the CPU 100 performs the processing of the flowchart illustrated in FIG. 5. Then, the CPU 100 exits the processing in this flowchart.

In step S702, the CPU 100 acquires the background image set in the home menu 300.

In step S703, the CPU 100 analyzes the acquired background image. More specifically, the CPU 100 measures the size of the background image, calculates the number of pixels, and detects the color of each pixel. Then, the CPU 100 divides pixels into blocks having a predetermined number of pixels, and converts the color difference between pixels for each block into numerical values.

In step S704, the CPU 100 determines whether the background image includes a predetermined logo. More specifically, in a case where the number of blocks where the numerical value indicating the color difference obtained in step S703 exceeds a threshold value is equal to or larger than a predetermined number, the CPU 100 determines that the background image includes a predetermined logo. In a case where the CPU 100 determines that the background image includes a predetermined logo (YES in step S704), the processing proceeds to step S705. In a case where the CPU 100 determines that the background image does not includes a predetermined logo (NO in step S704), the processing proceeds to step S710.

In step S705, the CPU 100 sets the area including the predetermined logo as a placement disabled area candidate.

In step S706, the CPU 100 determines whether the predetermined logo overlaps with the content placed in the home screen. In a case where the CPU 100 determines that the predetermined logo overlaps with the content placed in the home screen (YES in step S706), the processing proceeds to step S707. In a case where the CPU 100 determines that the predetermined logo does not overlap with the content placed in the home screen (NO in step S706), the processing proceeds to step S710.

In step S707, the CPU 100 displays the area of the placement disabled area candidate in the home screen. For example, the CPU 100 displays the home screen where the area of the placement disabled area candidate is surrounded by dotted lines.

In step S708, the CPU 100 determines whether the button 313 (application button) has been selected.

In a case where the CPU 100 determines that the button 313 has been selected (YES in step S708), the processing proceeds to step S709. In a case where the CPU 100 determines that the button 313 has not been selected (NO in step S708), the CPU 100 repeats the processing in step S708.

In step S709, the CPU 100 sets the area of the placement disabled area candidate as the placement disabled area. Then, the CPU 100 exits the processing in this flowchart. In response to completion of the processing in step S709 in FIG. 10 (in response to completion of the flowchart in FIG. 10), the CPU 100 performs the processing in steps S504 to S513 in FIG. 5.

The present exemplary embodiment has been described above centering on a form in which, in response to selection of a predetermined area of the background image, the selected predetermined area is set as a placement disabled area. With this configuration, even in a case where the placement area position of an application button and the number of placement areas in the home screen are changed, an area intended by the user is settable as a placement disabled area.

### Other Exemplary Embodiments

In the above-described exemplary embodiment, the application button (placement redo target application button) placed in the placement area set as the placement disabled area is placed again in a new placement area based on the placement priority. However, the present disclosure is not limited thereto. For example, the placement redo target application button may be moved to a blank area and placed therein in a predetermined page of the home screen. In a case where there is a plurality of blank areas, the placement redo target application button may be placed in the blank area recognized first with reference to the placement area in the Z-direction relative to the placement redo target application button.

The above-described blank area processing according to the above-described exemplary embodiment will be described below. There are two different types of blank areas: a true blank area and a blank area corresponding to an application button of which displaying setting is disabled. A true blank area is an area in which no application button is allocated in a placement area corresponding to the blank area, and is an area where no application button is displayed. A blank area set of which displaying setting is disabled is an area in which an application button is placed in a placement area corresponding to the blank area, and is an area in which displaying of the application icon and application name are set is disabled. For example, a blank area set of which displaying setting is disabled is an area in which the application icon and application name are translucently displayed in response to the user selecting the blank area based on a predetermined operation. Of these blank areas, the blank area of which display setting is disabled is settable as a target of a placement area in the flowchart in FIG. 5. However, a true blank area is not settable as a target of a placement area in the flowchart in FIG. 5.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-178031, filed Oct. 16, 2023, which is hereby incorporated by reference herein in its entirety.

What is claimed is:

1. An information processing apparatus having a plurality of functions, the information processing apparatus comprising:
a display control unit configured to display a screen on which a soft key indicating any one of the plurality of functions is placed, the screen including a background image;
a reception unit configured to receive a user operation performed to select a predetermined area where the soft key is not to be placed, in an area on the screen where the soft key is able to be placed; and
a setting unit configured to set the predetermined area,
wherein, in response to receipt of the user operation by the reception unit, the display control unit displays a confirmation screen indicating the screen in a state in which the predetermined area is set by the setting unit, and in a case where another user operation is performed to set the predetermined area on the confirmation screen, the display control unit displays the screen on which the predetermined area is set by the setting unit.

2. The information processing apparatus according to claim 1, wherein, even in a case where an operation is performed to place the soft key in the predetermined area in a state where the predetermined area is set by the setting unit, the soft key is not placed in the predetermined area.

3. The information processing apparatus according to claim 1, wherein the confirmation screen is a screen not displaying the soft key in the predetermined area on the screen and displaying a part of the background image.

4. The information processing apparatus according to claim 1, wherein the confirmation screen is a screen indicating a case where the predetermined area is set, and indicating a state where placement of the soft key displayed on the screen has been redone in an area other than the predetermined area.

5. The information processing apparatus according to claim 2, wherein the operation performed to place the soft key in the predetermined area in a state where the predetermined area is set is a drag operation on the soft key.

6. The information processing apparatus according to claim 1, wherein, even in a case where an operation is performed to place the soft key in the predetermined area in a state where the predetermined area is set, and the soft key is placed in a first position in an area other than the predetermined area, the display control unit displays a screen on which the soft key is placed not in the predetermined area but in the first position.

7. The information processing apparatus according to claim 1, wherein the display control unit does not display the soft key in the predetermined area on the screen but displays the soft key in an area other than the predetermined area on the screen.

8. The information processing apparatus according to claim 7, wherein, in response to receipt of an operation performed to specify the soft key on the screen by the reception unit, the setting unit sets an area including an area where the specified soft key is placed, as the predetermined area.

9. The information processing apparatus according to claim 8, wherein, in a case where the reception unit receives specification of the soft key issued to set the predetermined area, the display control unit displays the specified soft key in a display form different from the soft key not specified.

10. The information processing apparatus according to claim 1, further comprising:
a second setting unit configured to set a background image set as a background of the soft key on the screen,
wherein, in a case where the background image includes a predetermined logo, the setting unit automatically sets an area including the predetermined logo as the predetermined area, and
wherein, in a case where the background image does not include a predetermined logo, the setting unit sets, in response to receipt of an operation performed to select the soft key on the screen, an area including an area where the selected soft key is placed, as the predetermined area.

11. The information processing apparatus according to claim 10, further comprising:
a determination unit configured to determine whether the background image includes the predetermined logo, by analyzing the background image,
wherein, in a case where the determination unit determines that the background image includes a predetermined logo, the setting unit automatically sets an area including the predetermined logo as the predetermined area, and
wherein, in a case where the determination unit determines that the background image does not include the background image, the setting unit sets, in response to receipt of the operation performed to select the soft key on the screen, an area including an area where the selected soft key is placed, as the predetermined area.

12. The information processing apparatus according to claim 11,
wherein, in a case where determination that information about a color difference value of each pixel included in the background image exceeds a predetermined threshold value is performed, the determination unit determines that the background image includes the predetermined logo, and
wherein, in a case where determination that the information about the color difference value of each pixel included in the background image does not exceed the predetermined threshold value is performed, the determination unit determines that the background image does not include the predetermined logo.

13. The information processing apparatus according to claim 1, wherein, in a case where a first operation performed to select the soft key and a second operation performed to select a movement destination of the soft key on the screen are received, the soft key is placed in an area other than the predetermined area.

14. The information processing apparatus according to claim 1, wherein, in a case where a first operation performed to select an area where the soft key is able to be placed but the soft key is not placed, and a second operation performed to select a movement destination of an area where the soft key is able to be placed but the soft key is not placed on the screen, the soft key is placed in the area where the soft key is able to be placed but the soft key is not placed, in an area other than the predetermined area.

15. The information processing apparatus according to claim 1, wherein the information processing apparatus is a printer having a plurality of functions including at least a copy function.

16. A control method of an information processing apparatus having a plurality of functions, the control method comprising:
display controlling to display a screen on which a soft key indicating any one of the plurality of functions is placed, the screen including a background image;
receiving a user operation performed to select a predetermined area where the soft key is not to be placed, in an area on the screen where the soft key is able to be placed; and
setting the predetermined area,
wherein, in response to receipt of the user operation by the receiving, the display controlling displays a confirmation screen indicating the screen in a state in which the predetermined area is set by the setting, and in a case where another user operation is performed to set the predetermined area on the confirmation screen, the display controlling displays the screen on which the predetermined area is set by the setting.

17. A non-transitory computer-readable storage medium storing a program that causes a computer to operate as an information processing apparatus having a plurality of functions, the program comprising:
display controlling to display a screen on which a soft key indicating any one of the plurality of functions is placed, the screen including a background image;
receiving a user operation performed to select a predetermined area where the soft key is not to be placed, in an area on the screen where the soft key is able to be placed; and
setting the predetermined area,
wherein, in response to receipt of the user operation by the receiving, the display controlling displays a confirmation screen indicating the screen in a state in which the predetermined area is set by the setting, and in a case where another user operation is performed to set the predetermined area on the confirmation screen, the display controlling displays the screen on which the predetermined area is set by the setting.
